(19) United States
(12) Patent Application Publication
(10) Pub. No.: US 2002/0145742 A1
(43) Pub. Date: Oct. 10, 2002

(54) Multimedia laboratory notebook

(76) Inventors: Donna Koenig, Wyoming, MN (US); Ernest Brody, Minneapolis, MN (US); Paul Beshah, St. Louis Park, MN (US); Glenn Ward, Lauderdale, MN (US); Joseph Landry, Stony Brook, NY (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 09/832,322

(22) Filed: Apr. 10, 2001

(51) Int. Cl. G06F 17/30

(52) U.S. Cl. 358/1.1

(57) ABSTRACT

A system and method for providing a multimedia laboratory notebook that adheres to standard, scientific documentation procedures. The system includes a database for storing experiment records, a server and input devices. The experiment records are a combination of text, graphics, digital images and other media. The database stores all experiment records permanently, such that modifications to existing database records results in the creation of a new, discrete database record containing the modified experiment record. The initial experiment record is the parent record, and each modified version is linked to the previous parent record. The experiment records are associated with a deliverable, and access to the experiment record is controlled according to access to the deliverable.

### CROSS-REFERENCE TO RELATED APPLICATION(S)

None.

### BACKGROUND OF THE INVENTION

The present invention relates to documentation of experimental data, and more particularly to a method and apparatus for recording, storing, and retrieving the results of experiments in compliance with established lab practices.

For centuries, scientists have been hand-writing their experimental data, their results and their thoughts in bound paper notebooks. Archimedes, Leonardo Da Vinci, and Friedrich August Kekulé, for example, each recorded important and historically significant thoughts, observations and experiments in laboratory notebooks which are now preserved.

Traditional notebooks are easy to use, flexible and portable. The experiment text, notes and data may be supplemented in the notebook by pasting in photos, spectra, chromatograms, charts, and other information. The bound notebook is a permanent chronological record of the progress of the experiment, which provides a basis for establishing a time line of experimental milestones.

Hand-written laboratory notebooks provide information for future experiments. Notes, data and analysis contained in the notebooks may be summarized for publication, and may provide the basis for patent applications. Hand-written laboratory notebooks in adherence to established laboratory practices have been accepted by the courts as a basis for demonstrating priority of invention and reduction to practice. Thus, hand-written notebooks have long been used and have established legal precedent.

Nevertheless, hand-written notebooks have disadvantages. First, the hand-written notebook cannot be shared because only one person can have possession of the notebook at any given time. Second, hand-written notebooks lack the functionality and flexibility that current computers allow. Furthermore, the hand-written notebooks rely heavily on handwriting which may not always legible. The notebooks lack consistent organization because each person has a different style when it comes to recording data and experimental analysis in the notebook. Finally, the hand-written notebook has a page limit. Supplemental photographs, spectra, chromatograms, and other information, pasted into the notebook, can damage the notebook binding by causing the notebook to become unduly bulky.

In addition, hand-written notes are difficult to search. Typically, hand-written notes are indexed for future retrieval; however, the classification of the research, the organization, and the index category may vary from one scientist to another, making retrieval difficult for another scientist. Furthermore, in order to index the experiment notes, a data-entry person (typically someone other than the scientist) performs data entry into a table or database according to observations and data already recorded in the notebook. Thus, the data entry person recreates already existing information in digital form. Such data may be mistyped or entered incorrectly because hand-writing is messy, making retrieval more difficult.

Compounding these problems, proper indexing of the notebook requires that the notebook be taken from the scientist. The scientist loses access to his or her research materials for a period of time, thereby removing a potential resource for the scientist. In addition, whether in the hands of the scientist or the data entry person, notebooks can be lost. Furthermore, even if the research is indexed, the information may not be retrievable because the person searching simply does not know what key words to use. At least one company has reported having to repeat almost twenty-five percent of its scientists' experimental work because the hand-written records cannot be retrieved.

In a team environment, notebook documentation makes the exchange of research more difficult. To exchange notebook data with other team members, the scientist must duplicate the information and send it to another team member or simply send the entire notebook. Collaborative research must then be recorded in separate notebooks. Finally, hand-written notebooks leave report-writing as a wholly separate activity, because the text of the lab notebook does not exist in electronic form. Thus, the report must be separately generated.

It has long been desirable to have experimental data and research available electronically so that it may be easily searched and retrieved. The proliferation of computers both inside and outside of the laboratory environment, point to the increasing desirability of having a laboratory notebook software application. Furthermore, recent software and hardware advances have made it possible to combine text, graphics and other multimedia into single viewable documents.

The advantages of a multimedia laboratory notebook system are numerous: searchability, automated backups, remote accessibility, easy reproduction, legibility, expandability, flexibility, etc. A multimedia laboratory notebook can be faster, more complete, and neater.

However, existing database systems, by and large, do not fit the need of the scientific community. First, existing databases typically follow computer logic, which may or may not be appropriate to a particular experiment. Existing databases are relatively inflexible as compared with a paper notebook because they do not typically accept multiple formats for data input and because they are typically structured. The use of a computer-based system would require user training, which is not required by the traditional paper notebooks. Electronic sign-offs are relatively difficult, and electronic security remains a challenge.

In addition, the scientific community demands rigid adherence to standard documentation procedures. Typically, scientists sign and date the bottom of every page of the laboratory notebook, and the signature is often witnessed. In addition, unused areas of the page are lined-out in some way, so as to prevent someone from writing additional information on the page after the scientist has signed it. Data and experimental information is recorded in ink, so that it cannot be erased and changed. Finally, laboratory notebook is bound in advance, so that pages cannot be added to the notebook.

Generally, changing from the traditional hand-written paper notebook to a computer-based system requires a paradigm shift for scientists and members of the legal community. Typically, scientists and the legal community remain wary of new procedures, and concerns remain regarding the confidentiality, the security, and the credibility of data in such a database.

### BRIEF SUMMARY OF THE INVENTION

The present invention is an electronic, multimedia notebook for recording laboratory experiments. The multimedia notebook is a web-enabled, database in communication with the Internet, which permits multiple users to access on-going experimental records in a secure network environment. In the database, an experimental record is stored as a discrete record in non-volatile memory. Modifications and additions to the experimental record are made in volatile memory and then stored in the database as a new discrete record in nonvolatile memory. The new discrete record is linked to the original experimental record. The multimedia notebook permanently maintains a plurality of versions of each discrete experiment in a database. The multimedia notebook permits remote access to multiple users, allows sharing of notebook data and experimental records according to access permissions, and provides a means for searching and retrieving experiments and specific versions of an experimental record.

### BRIEF DESCRIPTION OF THE DRAWINGS

FIG. 1 is a block diagram of the system of the present invention.

FIG. 2 is a schematic diagram of the organizational hierarchy of the system of the present invention.

FIG. 3 is an illustration of linked database tables in the present invention.

FIG. 4 is a schematic flow diagram illustrating an overview of the set up process in the present invention.

FIG. 5 is a schematic flow diagram illustrating a scientist's interaction with the present invention.

FIG. 6 is a schematic flow diagram illustrating the creation of a new experiment record.

### DETAILED DESCRIPTION

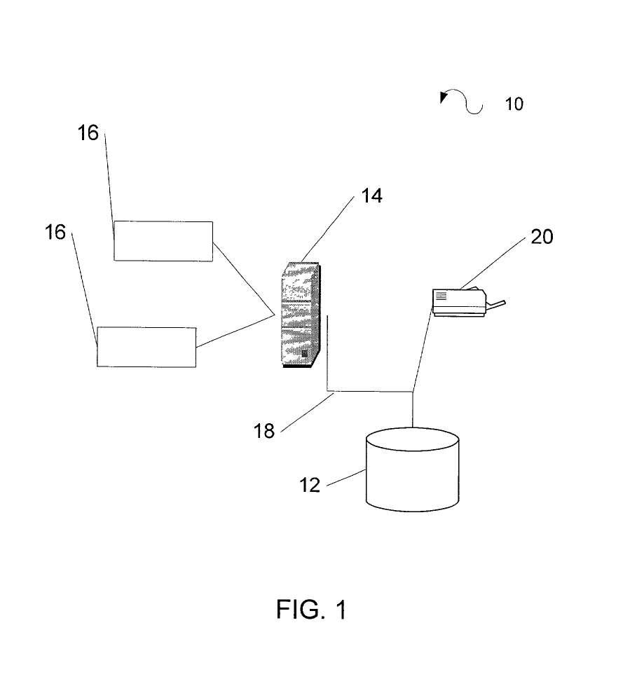

The present invention is a multimedia laboratory notebook system 10, which provides a structure and interface for documenting scientific research according to standard laboratory protocols. As shown in FIG. 1, the system 10 consists of a database 12 stored on a network file server or web server 14, which is accessible by input devices 16 over a network 18. The network 18 may be any Local Area Network (LAN) or Wide Area Network (WAN), or even the Internet.

The input devices 16 can be computer terminals, personal digital assistants (PDAs), document scanners, digital cameras, video cameras, sensors, probes, oscilloscopes, etc. Generally, the input devices 16 include any device that can input information to the database 12 directly or via the network 18.

The information may be sampled signals, text, graphics, images, sound, video and other data contained in a single file (a multimedia file). In the preferred embodiment, the stored copy of video is a static image taken from the video, rather than the entire video sequence because the video cannot be easily printed in the way that a static graphic image can. However, it is envisioned that the existing document paradigm of the scientific community may change over time, such that database records will become more acceptable as evidence of invention. In the event that such a paradigm shift occurs, video and sound information may become relevant to various experiments, and the present invention is capable of storing such information.

The text, graphics, images, etc. captured by individuals using any of the input devices 16 and then stored in the database 12 attached to an experiment record for later retrieval. The input devices 16 access the database 12 by modem (dial-up connection), wireless interface, 100/10 base-T Ethernet, Token Ring, or any other connection means.

As shown in FIG. 1, a server with a database 12 is in communication with input devices 16 and a printer over a network 18. The server may be any computer running a network operating system, such as Microsoft NT Server®, LanManager™, Novell®, Linux, etc. The server may also be a web server in network communication with a web-enabled database 12, meaning that the database 12 may be accessed from any web browser, such as Netscape®, Microsoft Internet Explorer™, Hot Java, etc.

Generally, the database 12 can be implemented in any computer language or using any database tool. In the preferred embodiment, Lotus Notes® is the development environment for the database 12 because the development interface is relatively easy to use and because Lotus Notes® does not permit the creation date to be altered.

In the preferred embodiment, the database 12 is web-enabled. Lotus Domino™ is server software that operates on a variety of server platforms (such as AS/400, Microsoft NT®, etc.), which extends Lotus Notes® applications to anyone with a web browser. Thus, in the preferred embodiment, the database 12 is implemented in Lotus Notes® and web-enabled using Lotus Domino™.

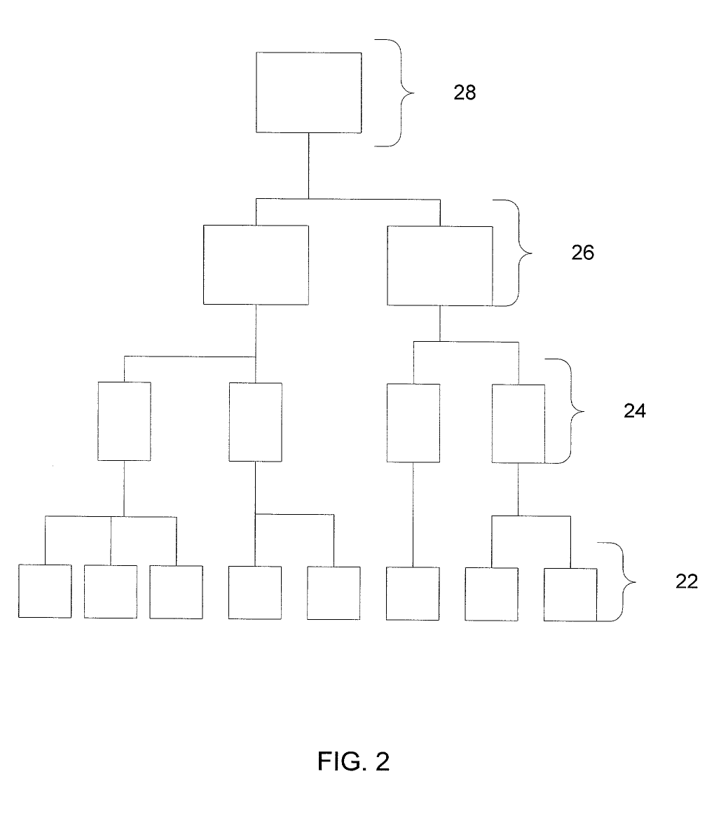

As shown in FIG. 2, the database 12 uses a hierarchical structure to organize experiments 22 within the database 12. Within the database 12, experiments 22 are grouped into sub-deliverables 24, which in turn are grouped into deliverables 26. Each deliverable 26 is associated with a research group 28, which is a subset of the research department. This hierarchy is intended to complement the structure and organization of a typical research and development department.

Within the database 12, user accounts are set up for each user on the system 10. Each user account contains a user name and a password. Within the system 10, users are organized into groups on the server called research groups. Research groups can exist on the server or in the database 12. In the preferred embodiment, the research groups 28 are sets of users within the database 12. Users may belong to more than one research group 28. Organizationally, users within a research group 28 assume responsibility for a particular goal or set of goals.

Goals or “objectives” are called deliverables 26. Typically, goals are intended to produce a good or product for commercial sale. Generally, deliverables 26 are broken down into sub-deliverables 24, which are discrete tasks that should be achieved in order to produce the Deliverable 26. The sub-deliverables 24 may also be referred to as tasks or sub-objectives. Finally, to achieve the sub-deliverables 24, scientists perform experiments 22.

Within the database 12, each discrete experiment 22 is linked to a single sub-deliverable 24. Each sub-deliverable 24 may be linked to multiple experiment records 22. In turn, each sub-deliverable 24 is linked to a single deliverable 26. In the preferred embodiment, the deliverable 26 is the parent record. Sub-deliverables 24 are “offspring” of the deliverable 26, and experiments 22 are “offspring” of the sub-deliverable 24.

Generally, any number of experiments 22 can be grouped under a single sub-deliverable 24. Similarly, any number of sub-deliverables 24 can be grouped under a single deliverable 26 within the database hierarchy. For access purposes, the system 10 controls access to an experiment record 22 by controlling access to its parent. Generally, a scientist has access to all experiment records 22 within the scientist's research group. Scientists have access to all deliverables 26 and subdeliverables 24, but experiment records 22 may not be accessed except by scientists within the related research group.

The system 10 provides security based on the user's association to a research group. Each research group is responsible for its own sub-deliverables 24, so members of the research group share access to all experiments 22 relative to that group. Thus, there is a security barrier against unauthorized access to proprietary experimental data as a protection against corporate spies.

Certainly, other strategies for securing access may be devised, but in the preferred embodiment, experiment records 22 are secure from unauthorized access according to membership in a research group. Generally, administrators and upper level management within the research department have read-only access to all experiment records.

In an alternative embodiment, experiments 22 can be linked directly to a deliverable 26. Also, access control can be experiment specific, such that scientists have access to experiment records 22 on a case-by-case basis. However, in the preferred embodiment, user accounts on the server 12 are grouped together into user groups or research groups 28 having shared permissions. Access rights to discrete experiments 22 are controlled at a “group” level, to minimize administrative burdens.

As shown in FIG. 2, the experiment 22 is the building block or basic unit of the multimedia notebook 10. Users of the multimedia notebook 10 are typically engineers or scientists within the research and development department. However, management, administrators and others may be given access to the database 12 for a variety of tasks, including monitoring on-going research, searching completed experiments for information relating to new or on-going experiments and so on.

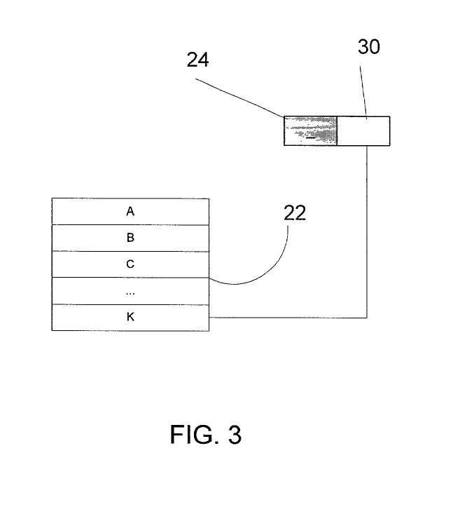

As shown in FIG. 3, a discrete experiment record 22 is linked to a sub-deliverable 24 in the database 12 via a pointer 30. Within the database table, the pointer 30 points to the most recent version (k) of the experiment record 22. Once the experiment record is saved or stored in the database 12, the experiment record is locked so that it cannot be altered. If a user opens an experiment record, the database 12 displays the most recent version (k) of the experiment record 22 as read-only. The user can alter only the read-only version of version (k) of the experiment record 22, but he or she cannot over-write the most recent version (k). Instead, system 10 generates a new version (l) based on the previous most recent version (k) of the experiment record 22. Only version (k) can be edited. Attempts to edit version J or any previous version of the experiment record 22 are not permitted. Modified experiment records 22 are stored in the database 12 in a new record that is linked to the parent experiment record (Experiment Version A). Thus, experiments 22 are permanently recorded in the database 12, and each experiment record 22 is preserved in total as it appeared at the time it was saved. Each version of the experiment record 22 is stored as a linked database record, which can be retrieved from the database 12 via the most current version (k) of the experiment record 22.

Each database record 22 in the present invention may include both text and graphics, images, sounds or video. Thus, each database record 22 is potentially a multimedia experiment record 22. If an experiment record 22 combines text and graphics, the size of the record 22 increases greatly according to the size of the graphic. All text, graphics, sound files, or files generated with another utility or device are stored in the database 12. Records 22 do not link to external files or documents.

As previously indicated, the database 12 is a database. Generally, a database can be described as a set of related database tables. Each database table contains rows and columns of information, and the information within a row of information is a set. Each set of information corresponds to an attribute of another database table. For example, a database table containing sub-deliverable information has a unique row of information for each sub-deliverable. Within that row, there is a sub-deliverable identifier that is unique within the sub-deliverable database table. Related experiment records 22, which exist in an experiment data table, contain the same sub-deliverable identifier corresponding to the parent sub-deliverable. Thus, the experiment and the sub-deliverable database tables are related via the sub-deliverable identifier. Similarly, the sub-deliverables are related to the deliverables via a shared deliverable identifier, which is unique to the deliverable 26 within the deliverable database table. Thus the database 12 is .

In order to provide a database, some mapping scheme must exist to pair the experiment record 22 with the database table entry of the sub-deliverable 24. Any mapping scheme will suffice, provided the hierarchy of relationships are maintained. In the preferred embodiment, deliverables, sub-deliverables and experiments are linked via their unique identifiers, respectively. These data can then be retrieved for further processing or for future reference at some later date.

In the case of video, sounds, or spreadsheet graphs or charts, the entire graphical file is stored inside the experiment record 22. With each modification, the graphical file is replicated in the new version. Thus, an on-going experiment, resulting in multiple additions and changes to a file will greatly increase the size of the database 12. Further, each subsequent version of the experiment record 22 will contain the graphical file.

Though a line-through method that stores only the changes from one version to the next and displays the current version by lining out deleted text and coloring additions might work to represent changes or modifications to an existing text file, leading to a smaller database “footprint,” graphics and video complicate the line-through method. Furthermore, the line-through method makes it difficult to identify changes and modifications relative to the date of the change.

Since authentication of experiment records 22 and the date of creation are crucial elements of experimental data, a versioning method that reflected changes without definitively dating the specific change would not survive the scrutiny of the scientific community. More importantly, changes to graphics and graphs may be difficult to ascertain without the ability to compare them side-by-side. By storing each experiment version in a separately retrievable, unmodifiable database record, authenticity is protected, and the ability to compare date-specific records is maintained. Thus, this method ofversioning the experiment record 22 by preserving each record without allowing modification directly addresses the concerns of the scientific community.

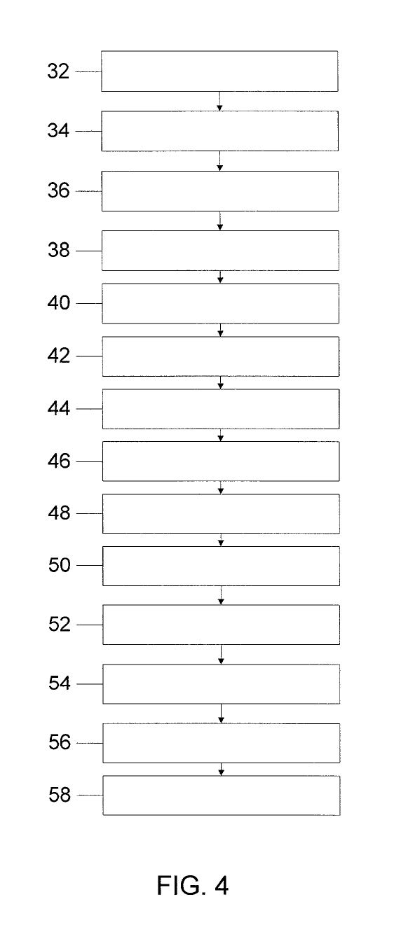

As shown in FIG. 4, the first step in proceeding with the database 12 involves creating deliverables and sub-deliverables. First, an administrator signs on to the database 12 (step 32). Next, the administrator defines users (step 34) of the database 12, including user names and passwords. Typically, this step is performed at the initial set up of the database 12, and subsequently, creation of user names and passwords occurs only to create new users when new employeesj oin the research department.

Next, the administrator defines a deliverable (step 36). A deliverable is a goal or an objective that is used to categorize experiments. T h e server 14 displays a deliverable form (step 38), which permits both text additions and which displays drop down menus for the administrator to enter information. The deliverable form includes the deliverable year, description, category, ID, project group, entry date, status, identifier, and objective. The deliverable year represents the current year for the research objective. The deliverable description represents a short description of the objective. The deliverable category represents acronyms for the appropriate area of research (for example, API for aseptic processing-industrial, BR for basic research, SP for spreads, and the like). The entry date is automatically generated by the system and may not be altered. The status represents the current status of the deliverable. The default status is “in process”. When an objective or deliverable is achieved, the user changes the status to “complete”. Finally, deliverable objectives are entered as free text from the research objectives list. The research objectives list is a list of objectives that is created by the department to assist in categorizing and describing the objectives of ongoing research. Other fields can be added and other information required to supplement the standard form.

The administrator completes the deliverable form (step 40) and submits or saves the form (step 42). If the administrator chooses to close the form before saving, the system will automatically prompt the user that the current form has not been saved to prevent inadvertent closure and loss of a new deliverable profile. Upon saving, the database 12 automatically generates a deliverable identifier (step 44) using the deliverable category and deliverable ID. In other words, the database 12 combines the deliverable category and deliverable ID to generate a deliverable identifier.

In the preferred embodiment, the deliverable year, description, category, ID, project group, and project group name are all entered by means of drop down menus. Though the use of drop down menus requires a great deal of up front set up time, the drop down menus standardize the entry form so that categories, IDs, groups, and names are uniform across the enterprise and typographical errors are eliminated. This uniformity of naming conventions simplifies searching, assists in identifying research subcategories, and provides a virtual subject index for later retrieval.

By providing menu items to assist in standard data entry, typographical errors are minimized. Data entry personnel do not mistype categories, group names or other frequently used data. Though data entry personnel can inadvertently select the wrong item in a drop down menu, such errors are typically easier to identify and fix.

Uniform naming conventions provide an enterprise-wide, recognizable format and categorization. As research departments grow, the potential for overlapping research increases. By standardizing naming conventions, research is made more efficient because results of experiments can be easily shared and retrieved. Further, in planning stages, the multimedia notebook can be used to retrieve existing experiment information so that research is not needlessly repeated.

Once the deliverable form is saved (step 42) and the deliverable identifier is generated (step 44), the system displays a deliverable view (step 46), which is a list of the deliverables 26. Similarly, when the administrator at a later time logs onto the system (step 38), the multimedia notebook 10 displays a deliverable view (step 46). The deliverable view window presents a number of options to the administrator. The administrator may either create a sub-deliverable, edit and save the deliverable 26, or close the form. The administrator may also print the deliverable form, perform searches, and so on.

The system anticipates the existence of numerous deliverables 26. Creation and entry of information relative to deliverables 26 may be performed all at once, one at a time, or at any time. For the sake of the present example, it is assumed that the administrator has entered a new deliverable 26, and is now going to proceed to create and define a sub-deliverable 24.

The data entry person or administrator pushes the “create sub-deliverable” button (step 48) in the deliverable form window. The system automatically saves the deliverable (step 42) and opens up a new window for entering information about the sub-deliverable 24 (step 50). In an alternative embodiment, the user must save the deliverable 26 manually, and the system 10 prompts the user to save and warns that data might be lost if the user does not save the form before proceeding.

The sub-deliverable window provides a number of options to the data entry person. In the sub-deliverable window, the data entry person may create an experiment 22, save the sub-deliverable profile, close the sub-deliverable window, print the sub-deliverable profile, or create a text summary of the sub-deliverable profile. In the sub-deliverable window, the sub-deliverable form contains the following fields: sub-deliverable year, deliverable identifier, deliverable description, project group, sub-deliverable ID, entry date, status, plant, tax credit eligible, cross reference, sub-deliverable identifier, sub-deliverable description, and sub-deliverable objective. As with the deliverable window, most of the fields are completed using drop menus. The sub-deliverable year is the current year for this research sub-deliverable, since some sub-deliverables are carried over from previous years. The deliverable identifier, deliverable description, and project group is automatically filled in by the system from information in the deliverable window. However, this information may be altered in the sub-deliverable profile window.

The sub-deliverable ID represents sub-deliverable research sub-objectives from an existing list in the system. The entry date is automatically generated by the system and placed or inserted into the field on the form (step 52).

The status is the current status of the sub-deliverable. The default status is “in process”. When a sub-deliverable is completed, the user changes the status to “complete”.

The plant field refers to the specific production facility for which the research is being conducted. The tax credit eligible field defaults to “no” but may be altered when appropriate. Some experiments 22 or sub-deliverables 24 may be eligible for tax credits.

The cross reference field permits the data entry technician to reference some other sub-deliverable 24 from which this sub-deliverable 24 derived. Advances accomplished in previous years may lead to new experiments, and the reference may be used to assist in providing background information. The process by which advances from a previous year leads to new experiments is commonly referred to as “branching.”

The sub-deliverable description is a short description of the research sub-objective. The sub-deliverable objective is the full research sub-objective. Typically, the sub-deliverable description and sub-deliverable objective are free text entry fields.

Upon completing the sub-deliverable form, the data entry technician may print the form, close the form, save the form or move on to create an experiment.

Typically, the data entry technician will save the form (step 54) and close the form. If the data entry technician closes the form before saving the form, the system will warn the data entry technician that the sub-deliverable form has not yet been saved so as to prevent loss of the entered information. The data entry technician may also print the form so that a paper copy exists for filing. When the data entry technician saves the form, the database 12 automatically generates the sub-deliverable identifier (step 56), based on the deliverable identifier and the sub-deliverable ID. In other words, the system automatically generates a sub-deliverable identifier by combining the deliverable identifier and sub-deliverable ID. Finally, the database 12 links the sub-deliverable to its parent deliverable (step 58).

In the multimedia notebook 10, security is maintained such that each research group 28 has access to the experiments 22 for which it is responsible. The research department managers may access all experiments 22 and/or sub-deliverables 24 as necessary. The specific security arrangement may vary according to departmental policies; however, in the preferred embodiment, the notebook 10 restricts access to experiment records 22 to the research group of scientists working on the associated sub-deliverable 24.

In the multimedia notebook 10, access rights and permissions within 25 the database 12 may be controlled. In the preferred embodiment, the ability to create new deliverables 26 and sub-deliverables 24 for a research group 28 are also controlled according to the user name and password such that creation of deliverables 26 and sub-deliverables 24 is limited to a select group of data entry technicians. First, the research and development group identifies a research objective. The data entry technician then creates a deliverable 26 in the database 12 and links that deliverable 24 to a research group 28. The data entry associated with the deliverable 24 is mostly in the form of drop-down menus to facilitate accuracy.

Data associated with the deliverable 24 includes the year, a short description, a category associated with the area of research (for example, API for aseptic processing-industrial, BR for basic research, SP for spreads, and the like), deliverable identification number, the project group, the entry date on which the deliverable 24 is created, status of the deliverable 24, and additional notes. Other information may be requested from the data entry technician at the time of creation of the deliverable 24, but this information is typically used for later retrieval and indexed searching. The status default entry is “in process,” because the experiment 22 will not be complete at the time the deliverable is entered into the database 12. An additional item which may be entered by the data entry technician is the deliverable objective. Typically the deliverable objective will be entered as free text and derives from a research objectives list.

The next step of the process involves a scientist. Generally, the scientist or engineer conducting the experiments is not responsible for creating deliverables 26 and sub-deliverables 24. Typically, the deliverables 26 and sub-deliverables 24 are objectives and goals that are created by the research department, and an administrator, data technician or manager creates the descriptions of the deliverable 26 and sub-deliverable 24. However, within each research department, the access rights or permissions may vary. In some instances, the deliverables 26 may be created by an administrator in the research department; however, the sub-deliverable 24 and experiments 22 are entered, created and managed by the scientist themselves. In the preferred embodiment, scientists manage only the experiments 22, and administrators manage the deliverables 26 and sub-deliverables 24.

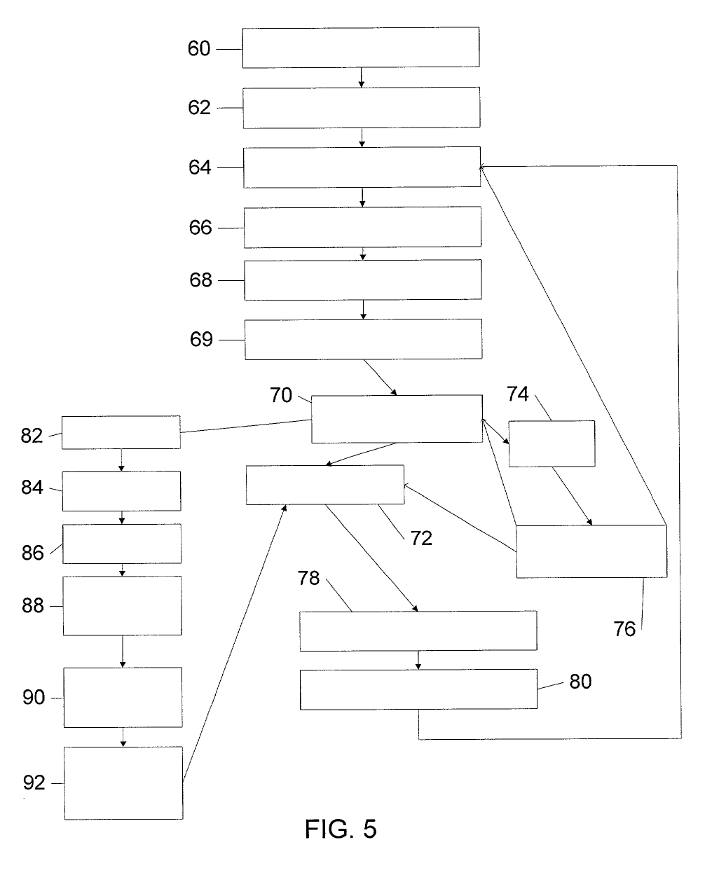

As shown in FIG. 5, a scientist signs on (step 60) to the multimedia notebook 10. Generally, authentication to the network 18 and access authorization to the database 12 are separate operations. Network authentication can be performed using any known authentication protocol, such as LDAP (lightweight directory access protocol) or Microsoft® Active Directory® Services. By contrast, access authorization for the database is typically handled by an internal user table within the database 12. However, it is not necessary that authentication and authorization be performed separately. In fact, in the case of Lotus Notes®, the server 14 may control both authorization and authentication.

The following description assumes that the scientist is already authenticated to the network 18. In the preferred embodiment, the scientist is responsible for maintaining experiment records 22 and editing the status of the related sub-deliverable 24 upon successful completion of the sub-deliverable 24 and associated experiments 22; however, the scientist is not responsible for creating deliverables 26 and sub-deliverables 24.

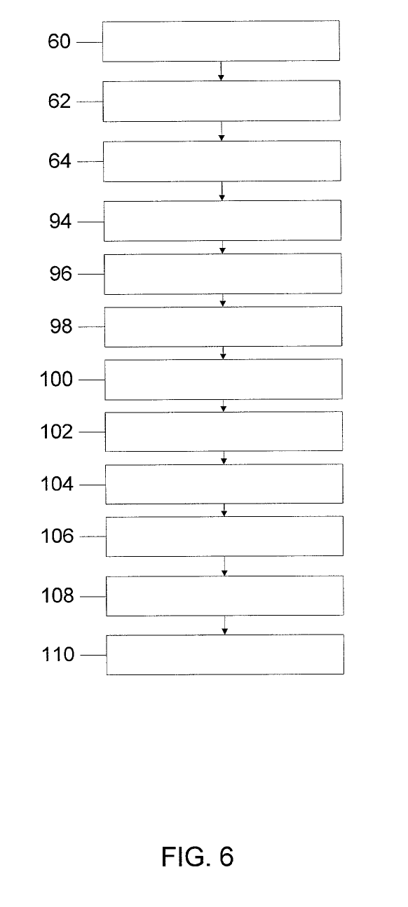

Once the scientist is logged onto the database 12, the multimedia notebook 10 retrieves the most recent versions of the experiments associated with this scientist (step 62) and displays them in a list (step 64). The scientist then selects an experiment 22 from the list (step 66). The notebook 10 also provides the scientist with the choice of creating a new experiment record (as discussed with respect to FIG. 6). However, generating a new record requires originating the creation process from within an existing sub-deliverable. The notebook 10 creates a unique identifier for the experiment record 22 and links the experiment record 22 to the parent sub-deliverable 24, by selecting from a list of existing sub-deliverables 24. The system 10 inserts the scientist's user name and provides a form for completion as described above.

Assuming the scientist selects an existing experiment 22 from the list, the notebook 10 displays the experiment record (step 68) as a “read-only” record. In order to append or edit the experiment record, the scientist pushes an “edit” button (step 69), which causes the notebook to generate a copy of the experiment record 22 in random access memory for editing. The scientist can then append the record, change its contents, add graphics or otherwise modify the file (step 70). Generally, the scientist may add text, whole files, video, images, sound, etc. The notebook 10 can be used to capture experimental data in real-time. For instance, in the case of an oscilloscope, experimental data can be captured by the oscilloscope and ported directly into the experiment record 22 through a serial connection to a computer workstation. Alternatively, graphs can be printed and pictures taken. The graphs and pictures can then be scanned into the computer. In another embodiment, a digital camera can be used as an input device 16 to capture digital images of the experiment. Thus, the experiment record 22 can be a multimedia combination of text, graphics and other dynamic information.

The notebook 10 displays the read-only experiment record 22 in volatile or Random Access Memory (RAM), so that changes are not stored in the database 12 until the scientist saves them (step 72). If the scientist begins editing the experiment record 22 and then unexpectedly closes the window (step 74), the notebook 10 displays a warning that information will be lost (step 76) unless it is saved and giving the scientist the option to save the experiment record 22, cancel, or not save the modified record. If the scientist does not save the record, no new record is created and the scientist is returned to the experiment list (step 64). If the scientist chooses to cancel the “close” operation, the read-only experiment record 22 remains in RAM for further modification (step 70). If the scientist saves the experiment record 22, the notebook 10 generates a new experiment record (step 78) in the database 12 and links the new experiment record to the parent experiment record 22 (step 80). Each time the experiment record 22 is saved or a new experiment record 22 is created, the database 12 automatically saves the date and time of the creation of the experiment record 22. This date and time stamp cannot be modified and is included in all print outs of the experiment record 22.

Once the experiment is complete, the scientist enters a conclusion into the body of the experiment record 22 (step 82). Then, the scientist enters the next steps to be taken with regard to the experiment 22 or sub-deliverable 24 (step 84) (for example seek patent protection, begin experiment on next step in process, etc.). Next, the scientist selects at least five key-words (step 86) to characterize the experiment record 22 to assist in future key-word searches. In the preferred embodiment, all key word entries are performed via pull down menus, which may be modified by the database administrator. In the event that a word must be added, an administrator adds the new word to the appropriate pull down menu. Thus, data entry errors can be minimized, and changes are effected through a single point to prevent overlap and unnecessary creation of new categories.

Next, the scientist enters the names of the scientists involved in the experiment (step 88) and the name of the witness (step 90) who will witness the signatures of the scientists. Then, the scientist changes the status of the experiment record 22 from “in progress” to “complete” (step 92) before saving the experiment (step 72). The database 12 automatically links the completed experiment record to the parent experiment record 22 (step 80).

A complete experiment 22 may be printed, signed by the scientists, and bound to preserve the experimental record in paper format. The printed version contains the most recent version of the experiment record 22, and a list of the modification dates of previous versions. Thus, the experiment record 22 is maintained in its entirety, including the dates of the earliest experimental record. Further, previous iterations or versions of the experiment record 22 may be retrieved and viewed within the database 12, but only the most recent version can be modified to generate the next version of the experiment record.

Generally, in addition to the experimental data, the experiment record contains the following fields: deliverable description, sub-deliverable identifier, sub-deliverable description, sub-deliverable cross reference, experiment title, author, experiment purpose, date, unique stamp, status, monthly highlights, creation date, sub-deliverable ID, text or data entry, keywords, invented by, recorded by, witnessed by, and completion date.

The deliverable description is imported from the deliverable and sub deliverable records. The sub-deliverable identifier, sub-deliverable description, and sub-deliverable cross reference are imported from the sub-deliverable record. The experiment title is entered as free text. The author is imported by the system based on the login identifier, but may be changed. The experiment purpose is entered as free text. The date is brought in by the system, and may not be altered. A unique stamp is created by the system, representing the year, month and day combined with the hours minutes and seconds or rather the time at which the experiment is created. The default status is “in process.” Changing the status of the experiment record 22 to “complete” and saving the experiment record 22 locks the experiment record 22 permanently, such that no further edits are permitted by the notebook 10. Further changes or addendums to the most recent version of the experiment record 22 are not permitted.

Upon completing the experiment, the scientist can create or add to a summary of the experiment record 22. The summary is a record that is linked to the sub-deliverable and is used to bring experiments and thoughts together. In other words, the summary provides a means for the scientist to organize, categorize and further describe experiments related to this sub-deliverable. Each scientist may use this summary differently. For example, one scientist might copy the text of the experiment record and paste the text into the summary. Another scientist may type a text description identifying the high points or identifying trends. Still another scientist might include a two-sentence description to serve as a reminder of the experiment. The summary can be text, video, sound or the like.

The summary is intended to assist in report writing by providing an area for the scientist to summarize findings and observations from the experiment. In addition, the summary provides a location in the database for the scientist to record thoughts and observations that are not directly related to the specific experiment.

As shown in FIG. 6, the scientist logs on to the database 12 (step 60). Generally, the notebook 10 displays the window that the scientist used most recently. For example, if the scientist edited an experiment record 22 in a previous session, the notebook displays the most recent version of the experiment record 22, in which the scientist was working. If the scientist last exited the program from the sub-deliverables window, the notebook 10 displays the sub-deliverable window after authenticating the scientist. The notebook 10 stores a cache for each registered user corresponding to the activities of the scientist in the database 12, which can be used by the database 12 to retrieve the last window viewed. Thus, the notebook 10 assists the scientist in resuming on-going work.

Assuming the scientist last exited the program from a page listing all experiments 22 associated with the scientist, the notebook 10 retrieves the most recent versions of experiments 22 associated with the scientist (step 62) and displays the list of retrieved experiments (step 64). If the scientist wishes to create a new experiment record 22, the scientist clicks on a button to view the sub-deliverable window (step 94). The notebook displays a list of sub-deliverables 24 according to the scientist's access rights (step 96). The scientist selects a sub-deliverable 24 from the list (step 98) and clicks a button to create a new experiment (step 100). The notebook 10 displays a new experiment window (step 102), which requires data entry regarding the new experiment. Specifically, the scientist is expected to enter a title, and other descriptive information relative to the new experiment. The notebook 10 automatically generates a unique experiment identifier in the form (step 104) and enters the sub-deliverable identifier into the form (step 106).

The scientist completes the new experiment form (step 108) and saves the experiment form (step 110) in the database. The experiment data, such as the title and other “metadata” information is contained in each version of the experiment record 22. The “metadata” is used to retrieve or to find the experiment record 22 at a later time. Thus, a new experiment record 22 is created through an existing sub-deliverable, establishing the parent-child link at the outset. Since the new experiment record 22 is created from within an existing sub-deliverable 24, and since the unique identifiers are entered automatically by the notebook 10, data entry errors in the linking process are eliminated. Thus, experiments 22 can be retrieved through the parent sub-deliverable.

In the preferred embodiment, a user can search the database 12 for information according to key word, author, status, research group, date or full text. Further, the database maybe searched according to a combination of the above list using a Boolean logic or natural language search engine. Depending on the permissions associated with the user, the user may have access to only a limited number of experiment records. The database search engine compares the search terms against text stored in the experiment records and returns a “hit list,” a list of experiment records 22 containing the search text.

The multimedia notebook 10 provides a means for storing experiment data, images, charts and other interpretations of experiment data. The combination of text and graphics presents a complete description of the experiment, any analysis, and the conclusion. The notebook 10 permanently records all experiment records 22, such that changes and additions result in the creation of a new experiment record 22. The final version of the experiment record 22 is legible, complete, and date stamped. No further data entry is required to index the experiment or to make it possible to search the experiment data. Furthermore, the experiment record 22 can be printed to a text file or copied and pasted into a document directly from the experiment record 22, making report-writing and publishing much simpler in that data does not need to be re-entered.

In some instances, it is desirable to generate interim reports based on an on-going experiment. The multimedia notebook 10 can easily print the most recent version of an experiment record 22 to a printer 20 or to a file for incorporation into an interim report. Data, graphs and other observations do not need to be reentered in order to complete the interim report. Additionally, the summary may be used to assist in generating the interim reports. Text in the summary or the experiment record 22 may be copied from the database 12 into a text document for editing and formatting.

Each time the experiment record 22 is altered, the scientist's name and the date of the change are recorded in the new experiment record 22. Every scientist who ever edited the experiment record 22 is listed in the experiment record; however, only the most recent six appear in the list at the end of the experiment record 22. While additional names could be maintained beyond the six listed, in the preferred embodiment, the last six are displayed. Generally, the list of name provides a simple audit trail for changes made to the experiment record 22. Based on the date stored with the name, determining who last edited the experiment record 22 is simply a matter of comparing dates. Thus, this simple audit trail provides a means for determining who contributed “specific items or aspects” to the experiment; in other words, who wrote what. This feature can be extremely useful for determining whether a particular scientist contributed to the claimed invention (for patent purposes).

In the preferred embodiment, the database 12 is backed up regularly onto permanent optical or magnetic media. Though paper notebooks may be lost, the multimedia notebook 10 provides a means to store experiment records permanently, to restore them from backup in the event of a computer failure, to generate reports directly from the notebook 10, and to share the experimental data with remote users. By web-enabling the database 12, scientists at other research locations can access the same experiment record 22 as a scientist locally. Furthermore, more than one scientist at a time can open the experiment record 22. Using file locking, the database 12 ensures that only one scientist at a time can modify the most recent version of an experiment record; however, more than one scientist can view the most recent version of the experiment 22, thereby keeping abreast of progress in an on-going experiment.

Since the multimedia notebook 10 permits data entry in multiple forms, including free text, tables, digital photographs or scans, handwritten documents scans, chromatograms and spectra, the notebook 10 is more flexible than a handwritten laboratory notebook. The experiment record 22 expands to incorporate new information without stressing any binding. Furthermore, graphs and charts created in other programs are not linked but rather stored in the database, so that changes made to a graph or chart in another program does not impact the saved version. Thus, the experiment record 22 is preserved.

It is possible to implement the above described multimedia notebook in a variety of formats including LinkWorks®, Documentum®, Virtual Notebook® System, and Lotus Notes®; however, Lotus Notes® is the preferred groupware program because it is simple to configure and it does not allow modification of the creation date.

Although the present invention has been described with reference to preferred embodiments, workers skilled in the art will recognize that changes may be made in form and detail without departing from the spirit and scope of the invention.

1. A system for providing a multimedia laboratory notebook, the system comprising:
a database for permanently storing experiment records;
a server for providing secure network access to the database;
input devices in communication with the server for inputting information into the experiment records in the database;
wherein each experiment record contains information relative to a scientific experiment, the experiment record being a combination of text and graphics.

2. The system according to claim 1, the system further comprising:
a printer for generating an experiment report for binding and storing the experiment record with traditional laboratory notebooks.

3. The system according to claim 1, wherein the server is a web-server and wherein the database is web-enabled, such that a remote user interacts with the database using an Internet web browser over an Internet connection.

4. The system according to claim 1, wherein the input devices comprise:
a computer processor for entering text information.

5. The system according to claim 1, wherein the input devices are a scanner, a personal digital assistant, a digital camera, or a video camera.

6. The system according to claim 1, wherein the input devices are an oscilloscope, a probe, or a sensor.

7. The system according to claim 1, wherein the database prevents modification of an existing experiment record, such that changing the existing experiment record causes the database to store a modified experiment record as a new record in linked relation to the existing experiment record.

8. The system according to claim 1, wherein the experiment records are linked to a discrete deliverable, the database providing user access to the experiment records indirectly by controlling user access to the discrete deliverable.

9. The system according to claim 1, wherein the database comprises:
a user interface;
a search engine for retrieving experiment records from the database according to input from a user;
a first version record for storing an original version of the experiment record, a linker variable to link the experiment record to a deliverable, and a unique experiment identifier; and
a second version record related to the first version record according to the unique experiment identifier, the second version record being a complete modified version of the first version record, the second version record stored in the database as a new record;
wherein the first version record remains unaltered in the database.

10. A system for recording experimental data, the system comprising:
a database for storing multimedia records;
a user interface for interacting with the database, the user interface providing a structured means for inputting information into the database;
a search engine accessible from the user interface for retrieving multimedia records from the database according to input from a user; and
a version manager for preventing modification of multimedia records such that multimedia records are permanent.

11. The system according to claim 10, wherein the user interface permits the user to retrieve a discrete multimedia record, the user interface displaying the discrete multimedia record on a processor, the user interface permitting modification of the discrete multimedia record in volatile processor memory, and
wherein the version manager causes the modified discrete multimedia record to be stored in a new record in the database in nonvolatile memory such that the discrete multimedia record remains unchanged and separate from the new record.

12. The system according to claim 11, wherein the version manager links the new record to the discrete multimedia record.

13. The system according to claim 10, wherein the user interface is a web-based interface permitting interaction between the user and the database via a web browser.

14. The system according to claim 10, the system further comprising:
graphical input devices for importing images and graphics into the multimedia record.

15. The system according to claim 10, the system further comprising:
sensors for sensing discrete data and importing the discrete data into the multimedia record.

16. A method for providing a digital laboratory notebook, the method comprising:
creating user accounts in a database, each user account corresponding to a user;
permitting the user to create discrete experiment records in the database, each discrete experiment records being associated with the user;
providing access to the experiment records in the database according to the user accounts;
storing permanently the discrete experiment records in the database, each discrete experiment record being unalterable.

17. The method according to claim 16, the method further comprising:
retrieving the discrete experiment record according to input from the user.

18. The method according to claim 17, the method further comprising:
displaying the discrete experiment record as a temporary record in volatile memory on a processor, the user being permitted to alter the temporary record; and
storing the temporary record as a new discrete experiment record in the database, the new discrete experiment record being linked to the discrete experiment record.

19. The method according to claim 16, the method further comprising:
printing an experiment onto paper via a printing device, the experiment being a paper representation of a most recent version of the experiment record;
requiring the user to sign the experiment; and
binding the signed experiment into a book.

20. The method according to claim 16, the method further comprising:
permitting a plurality of discrete users to access the experiment record.
